(19) United States
(12) Patent Application Publication
(10) Pub. No.: US 2023/0018095 A1
(43) Pub. Date: Jan. 19, 2023

(54) DISTANCE MEASURING DEVICE, METHOD OF CONTROLLING DISTANCE MEASURING DEVICE, AND ELECTRONIC APPARATUS

(71) Applicant: SONY SEMICONDUCTOR SOLUTIONS CORPORATION, KANAGAWA (JP)

(72) Inventors: KUMIKO MAHARA, TOKYO (JP); HAYATO KAMIZURU, KANAGAWA (JP); NOBUHARU SUZUKI, KANAGAWA (JP)

(21) Appl. No.: 17/757,005

(22) PCT Filed: Nov. 17, 2020
(86) PCT No.: PCT/JP2020/042746

§ 371 Date: Jun. 7, 2022

(30) Foreign Application Priority Data
Dec. 20, 2019 (JP) 2019-230170

(51) Int. Cl. G01S 7/4865; G01S 17/894; G06V 40/16

(52) U.S. Cl. CPC G01S 7/4865; G01S 17/894; G06V 40/161; G06V 40/172

(57) ABSTRACT

A distance measuring device of the present disclosure includes a light source section that irradiates a subject with light, a light receiving device that receives reflected light from the subject, and an application processor that controls the light source section and the light receiving device. The light receiving device has an object detection function of measuring a distance to the subject to detect that the subject approaches within a predetermined distance, and provides notification of a detection result to the application processor in a standby state. The application processor starts up in response to the notification from the light receiving device.

### TECHNICAL FIELD

The present disclosure relates to a distance measuring device, a method of controlling a distance measuring device, and an electronic apparatus.

### BACKGROUND ART

In recent years, mobile terminals (mobile devices), such as a smartphone, equipped with a face authentication system as one of personal authentication systems have been in widespread use. In order to read accurate data of a face, the face authentication system performs, for example, processing for acquiring a three-dimensional (3D) image such as facial irregularities, that is, a distance map image (a depth map image). In order to acquire the distance map image, a mobile terminal such as a smartphone is equipped with a distance measuring device that measures a distance to a face as a subject.

Incidentally, a mobile terminal such as a smartphone uses a battery as an operation power source of the mobile terminal; therefore, reduction in power consumption of the mobile terminal is desired. For this reason, a mobile terminal is equipped with a proximity sensor (a short distance sensor) to perform ON/OFF switching of a touch panel display, for example, on the basis of information about whether or not the face of a user approaches the mobile terminal, thereby achieving a saving of power consumption of the mobile terminal (see PTL 1, for example).

### CITATION LIST

### Patent Literature

PTL 1: Japanese Unexamined Patent Application Publication No. 2014-027386

### SUMMARY OF THE INVENTION

### Problem to be Solved by the Invention

In related art described in the above PTL 1, it is possible to achieve reduction in power consumption of a mobile terminal; however, the mobile terminal is equipped with a proximity sensor in addition to a distance measuring device, which leads to an increase in the number of components, resulting in hindrance to size reduction of the mobile terminal and an increase in the price of the mobile terminal.

An object of the present disclosure is to provide a distance measuring device having a function as a proximity sensor in addition to a function of acquiring a distance map image (a depth map image), a method of controlling the distance measuring device, and an electronic apparatus including the distance measuring device.

### Means for Solving the Problem

A distance measuring device of the present disclosure to achieve the above-described object includes:

a light source section that irradiates a subject with light;

a light receiving device that receives reflected light from the subject; and

an application processor that controls the light source section and the light receiving device, in which

the light receiving device has an object detection function of measuring a distance to the subject to detect that the subject approaches within a predetermined distance, and provides notification of a detection result to the application processor in a standby state, and

the application processor starts up in response to the notification from the light receiving device.

A method of controlling a distance measuring device of the present disclosure to achieve the above-described object includes:

upon control of the distance measuring device including a light source section that irradiates a subject with light, a light receiving device that receives reflected light from the subject, and an application processor that controls the light source section and the light receiving device,

measuring a distance to the subject to detect that the subject approaches within a predetermined distance, and providing notification of a result of such detection to the application processor in a standby state to start up the application processor.

An electronic apparatus of the present disclosure achieve the above-described object is provided with a distance measuring device, the distance measuring device including:

a light source section that irradiates a subject with light;

a light receiving device that receives reflected light from the subject; and

an application processor that controls the light source section and the light receiving device, in which

the light receiving device has an object detection function of measuring a distance to the subject to detect that the subject approaches within a predetermined distance, and provides notification of a detection result to the application processor in a standby state, and

the application processor starts up in response to the notification from the light receiving device.

### BRIEF DESCRIPTION OF THE DRAWINGS

FIG. 1 is a conceptual diagram of a distance measuring device that adopts a ToF scheme.

FIG. 2 is a block diagram illustrating an example of a system configuration of a distance measuring device of the present disclosure.

FIG. 3 is a block diagram illustrating an example of configurations of an imaging section and its peripheral circuits in a light detector.

FIG. 4 is a circuit diagram illustrating an example of a circuit configuration of a pixel in the imaging section.

FIG. 5 is a timing waveform diagram for describing calculation of a distance by an indirect ToF scheme.

FIG. 6A is an explanatory diagram of normal distance measurement for acquiring a distance map image, and FIG. 6B is an explanatory diagram of simple distance measurement.

FIG. 7 is a block diagram illustrating an example of a basic system configuration of a distance measuring device according to Example 1.

FIG. 8 is a diagram illustrating a sequence image of the distance measuring device according to Example 1.

FIG. 9 is a diagram illustrating an activated block image in an “LP blank” state.

FIG. 10 is a diagram illustrating an activated block image in an “LP distance measurement” state.

FIG. 11 is a diagram illustrating an activated block image in an “imaging” state.

FIG. 12 is a diagram illustrating an image of an operation mode of a light source section according to Example 2.

FIG. 13 is a flowchart illustrating an example of a flow of processing of a proximity object detection sequence according to Example 3.

FIG. 14 is a block diagram illustrating an example of a basic system configuration of a distance measuring device according to Example 4.

FIG. 15 is a diagram illustrating a sequence image of the distance measuring device according to Example 4.

FIG. 16 is a block diagram illustrating an example of a configuration of a light receiving device in the distance measuring device according to Example 4.

FIG. 17 is a diagram illustrating an image of an operation mode of a light source section according to Example 5.

FIG. 18 is a flowchart illustrating an example of a flow of processing of a proximity object detection-face detection sequence.

FIG. 19A is an external view of a smartphone according to a specific example of an electronic apparatus of the present disclosure as viewed from front side, and FIG. 19B is an external view of the smartphone as viewed from back side.

### MODES FOR CARRYING OUT THE INVENTION

Hereinafter, modes for carrying out the technology of the present disclosure (hereinafter referred to as “embodiments”) are described in detail with reference to the drawings. The technology of the present disclosure is not limited to the embodiments, and various numerical values and the like in the embodiments are illustrative. In the following description, the same components, or components having the same function are denoted by the same reference signs, and redundant description is omitted. It is to be noted that description is given in the following order.
1. Overall Description of Distance Measuring Device, Method of Controlling Distance Measuring Device, and Electronic Apparatus of Present Disclosure
2. Distance Measuring Device of Present Disclosure

2-1. System Configuration

2-2. Configuration Example of Imaging Section

2-3. Circuit Configuration Example of Pixel

2-4. About Calculation of Distance by Indirect ToF Scheme

2-5. About Acquirement of Image

2-6. About Power Consumption of Distance Measuring Device
3. Embodiments of Present Disclosure

3-1. Example 1 (An example of a light receiving device that is able to perform monitoring of a startup timing and startup notification in a stand-alone manner with low power consumption)

3-2. Example 2 (A configuration example of a light source section in a distance measuring device according to Example 1)

3-3. Example 3 (An example of a proximity object detection sequence in the distance measuring device according to Example 1)

3-4. Example 4 (An example of a light receiving device that is able to perform monitoring of a startup timing, face detection and face authentication, and startup notification in a stand-alone manner with low power consumption)

3-5. Example 5 (A configuration example of a light source section in a distance measuring device according to Example 4)

3-6. Example 6 (An example of a proximity object detection-face detection sequence in the distance measuring device according to Example 4)
4. Modification Examples
5. Electronic Apparatus of Present Disclosure (An example of a smartphone)
6. Possible Configurations of Present Disclosure

### <Overall Description of Distance Measuring Device, Method of Controlling Distance Measuring Device, and Electronic Apparatus of Present Disclosure>

In a distance measuring device, a method of controlling the distance measuring device, and an electronic apparatus of the present disclosure, a light receiving device may be configured to perform switching of an internal status of the light receiving device on the basis of a detection result. In addition, the light receiving device may be configured to perform switching of the internal status of the light receiving device or switching of a status of a light source section on the basis of the detection result.

In the distance measuring device, the method of controlling the distance measuring device, and the electronic apparatus of the present disclosure including the preferred configurations described above, the light source section may be configured to irradiate a subject with pulsed light to be emitted in a predetermined cycle. At this time, the light receiving device may be configured to perform simple distance measurement by receiving reflected pulsed light from the subject and measuring a time of flight of light from a phase difference between a light emission cycle and a light reception cycle.

In addition, in the distance measuring device, the method of controlling the distance measuring device, and the electronic apparatus of the present disclosure including the preferred configurations described above, the light source section may have a configuration in which at least one of a frequency or a light emission amount of the pulsed light to be emitted is variable and at least one of the frequency or the light emission amount of the pulsed light is decreased in the simple distance measurement as compared with a case of distance measurement for acquiring distance map image.

In addition, in the distance measuring device, the method of controlling the distance measuring device, and the electronic apparatus of the present disclosure including the preferred configurations described above, the light receiving device may be configured to perform imaging in a continuous light emission state, thereby allowing for acquirement of an image, and may be configured to perform face detection on the basis of an acquired image.

In addition, in the distance measuring device, the method of controlling the distance measuring device, and the electronic apparatus of the present disclosure including the preferred configurations described above, the light receiving device may be configured to perform impersonation confirmation by detecting facial irregularities on the basis of the acquired image and comparing the facial irregularities with preregistered data. In addition, an application processor may be configured to perform face authentication on the basis of a distance map image in response to notification of face detection from the light receiving device.

### <Distance Measuring Device Adopting ToF Scheme>

One of distance measurement schemes for measuring a distance to a distance measurement target (a subject) is a ToF scheme that measures a time until light emitted from a light source section toward the distance measurement target returns after being reflected by the distance measurement target, that is, a time of flight (Time of Flight).

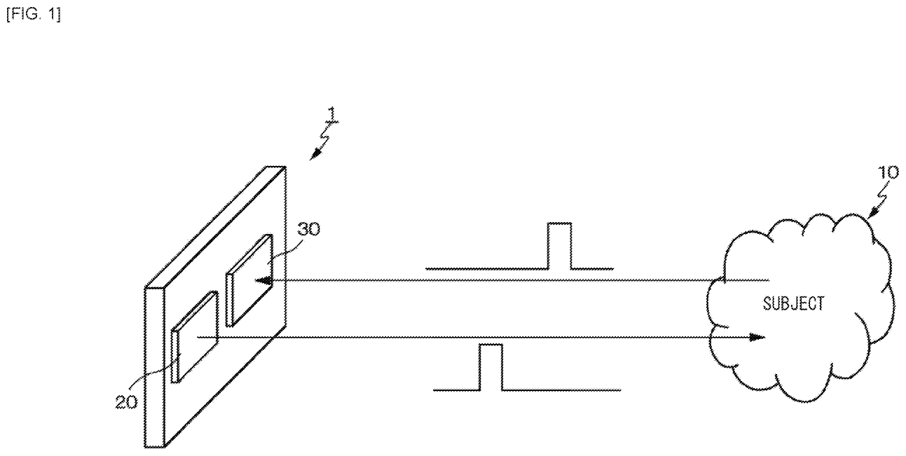

FIG. 1 illustrates a conceptual diagram of a distance measuring device that adopts the ToF scheme. In order to achieve distance measurement by the ToF scheme, a distance measuring device 1 is configured to include a light source section 20 that emits light toward a subject 10, and a light receiving device 30 that receives light returning after being reflected by the subject 10. The light source section 20 includes, for example, a laser light source that emits laser light having a peak wavelength in a infrared wavelength region. The light receiving device 30 is a light detector that detects reflected light from the subject 10, and is a ToF sensor that adopts the ToF scheme.

### <Distance Measuring Device of Present Disclosure>

### [System Configuration]

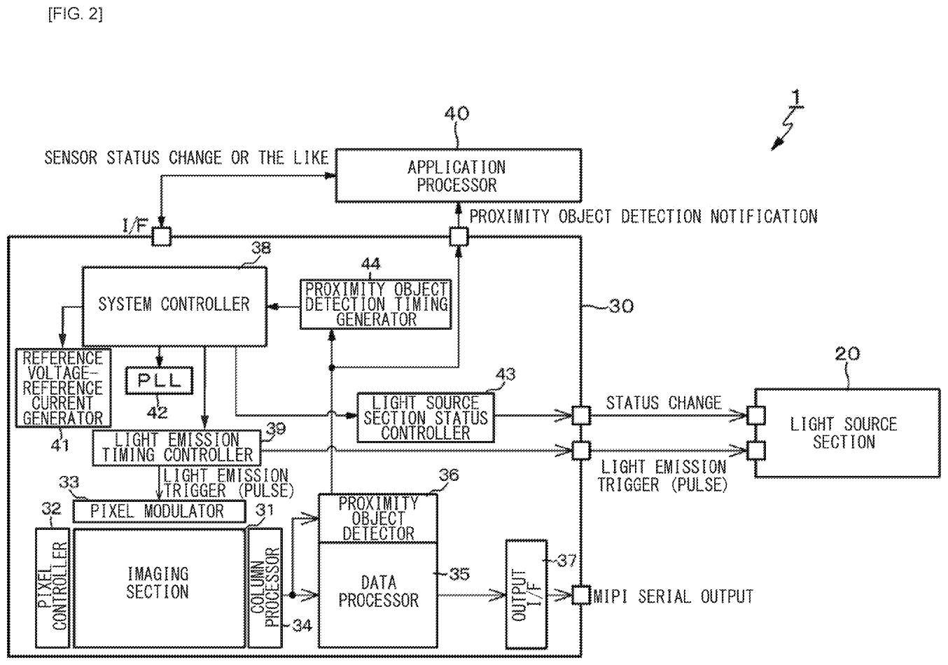

FIG. 2 is a block diagram illustrating an example of a system configuration of the distance measuring device of the present disclosure. The distance measuring device 1 of the present disclosure includes the light source section 20, the light receiving device 30, and an application processor 40. Change in a sensor status between the light receiving device 30 and the application processor 40, or the like is performed via an interface (I/F) such as an I2C/SPI. The application processor 40 controls the light source section 20 and the light receiving device 30.

In the distance measuring device 1 of the present disclosure, the light source section 20 irradiates a distance measurement target (a subject) with pulsed light to be emitted in a predetermined cycle. The light receiving device 30 receives reflected pulsed light from the distance measurement target (the subject) based on the pulsed light emitted by the light source section 20. Then, the light receiving device 30 detects a cycle of receiving the reflected pulsed light, and measures a time of flight of light from a phase difference between a light emission cycle and a light reception cycle to measure a distance to the distance measurement target. This distance measurement scheme is an indirect (indirect) ToF scheme. The distance measuring device 1 of the present disclosure adopts the indirect ToF scheme.

The light receiving device 30 includes an imaging section (a pixel array section) 31 in which pixels each including a light receiving element (a photoelectric conversion element) to be described later are two-dimensionally arranged in a matrix form (an array form). The light receiving device 30 includes a pixel controller 32, a pixel modulator 33, a column processor 34, a data processor 35, a proximity object detector 36, and an output I/F (interface) 37 as peripheral circuits of the imaging section 31, in addition to the imaging section 31.

Signals of the respective pixels two-dimensionally arranged are read from the imaging section 31 under control and modulation by the pixel controller 32 and the pixel modulator 33. Pixel signals read from the imaging section 31 are supplied to the column processor 34. The column processor 34 includes an AD (analog-digital) converter provided corresponding to a pixel column of the imaging section 31, and converts analog pixel signals read from the imaging section 31 into digital signals, and supplies the digital signals to the data processor 35 and the proximity object detector 36.

The data processor 35 executes predetermined signal processing such as CDS (Correlated Double Sampling: correlated double sampling) processing on the digitalized pixel signals supplied from the column processor 34, and thereafter outputs the pixel signals in units of imaging frames to outside of the light receiving device 30 via the high-speed output I/F 37 such as an MIPI.

Using pixel signals for a plurality of frames outputted in units of imaging frames from the light receiving device 30 makes it possible to generate a distance map (Depth Map: depth map) image that is applicable to a face authentication system and the like. Generation of the distance map image is performed, for example in the application processor 40 on the basis of the pixel signals for the plurality of frames outputted from the light receiving device 30. However, generation of the distance map image is not limited to generation in the application processor 40.

The proximity object detector 36 is turned to a proximity object detection mode by setting from outside such as the application processor 40. The proximity object detection mode is, for example, an operation mode that is set in a case where it is desired to acquire simple distance information such as how far a distance to an object is, a case where it is desired to determine whether or not an object is present in a specific distance range, and the like.

The proximity object detector 36 is turned to an operation mode when being set to the proximity object detection mode, specifies a partial region of the imaging section 31 as a target region for distance calculation, and calculates distance information to the distance measurement target with use of pixel signals in the target region and determines whether or not the calculated distance information satisfies a preset detection condition. Here, the detection condition is preset distance information (a distance value). When the calculated distance information satisfies the detection condition, the proximity object detector 36 notifies the application processor 40 that a proximity object has been detected.

The light receiving device 30 includes the proximity object detector 36 having a function of calculating distance information and a function of determining the detection condition to thereby have a function equivalent to a function of a proximity sensor. In other words, the distance measuring device 1 including the light receiving device 30 has a function as the proximity sensor in addition to a function of acquiring a distance map image (a depth map image).

It is to be noted that when setting to the proximity object detection mode, the pixel signals in the target region for distance calculation, that is, a partial region of the imaging section 31 are used, which makes it possible to start up only partial circuit portions relating to reading of the pixel signals in the partial region in the pixel controller 32, the pixel modulator 33, and the column processor 34. In other words, it is possible to stop operations of circuit portions not relating to reading of the pixel signals in the partial region.

It is possible to stop the operations of the circuit portions not relating to reading of the pixel signals in the partial region by turning the circuit portions to a standby state, stopping supply of a clock to the circuit portions, or stopping (shutting off) electric power supply to the circuit portions. Stopping the operations of the circuit portions not relating to reading of the pixel signals in the partial region makes it possible to reduce power consumption of the light receiving device 30 by power consumption of the circuit portions.

The light receiving device 30 includes a system controller 38, a light emission timing controller 39, a reference voltage-reference current generator 41, a PLL (Phase Locked Loop: phase locked loop) circuit 42, a light source section status controller 43, and a proximity object detection timing generator 44, in addition to the imaging section 31, the pixel controller 32, the pixel modulator 33, the column processor 34, the data processor 35, the proximity object detector 36, and the output I/F 37 that are described above.

The system controller 38 is configured with use of, for example, a CPU (Central Processing Unit), and performs communication and control of an entire system of the light receiving device 30, startup and stop sequence control, status control, and the like. Control by the system controller 38 also includes control of a light emission amount of the light source section 20 and switching of a light emission frequency, and the like.

The light emission timing controller 39 supplies a light emission trigger (pulse) to the light source section 20 and the pixel modulator 33 under control by the system controller 38. The reference voltage-reference current generator 41 generates various types of reference voltages and reference currents that are to be used in the light receiving device 30, under control by the system controller 38. The PLL circuit 42 generates various types of clock signals that are to be used in the light receiving device 30, under control by the system controller 38.

The light source section status controller 43 performs control of status change on the light source section 20 under control by the system controller 38. Status change from the light source section status controller 43 to the light source section 20 is performed via an interface such as an I2C/SPI or a control line. The proximity object detection timing generator 44 includes a timer for managing a timing of performing proximity object detection. Notification of proximity object detection is supplied from the proximity object detector 36 to the proximity object detection timing generator 44.

### [Configuration Example of Imaging Section]

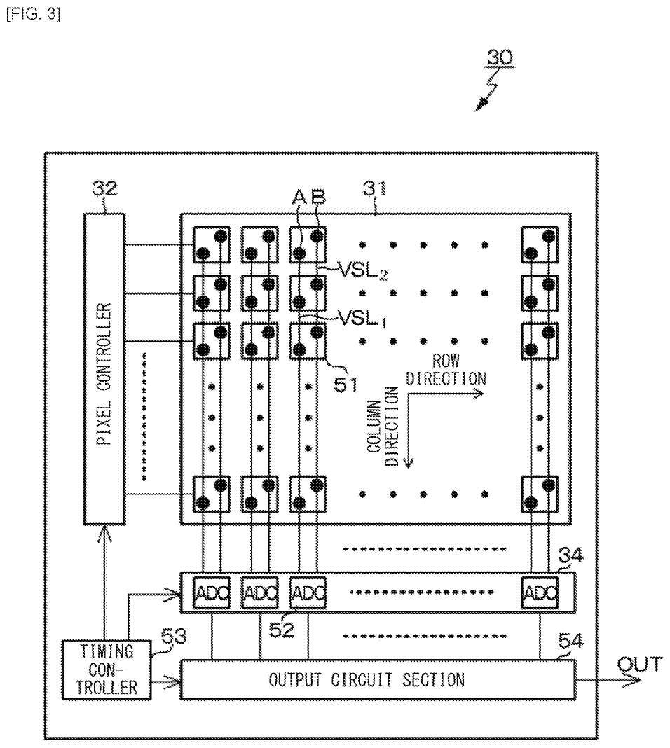

Here, description is given of a configuration example of the imaging section 31 in the light receiving device 30 with reference to FIG. 3. FIG. 3 is a block diagram illustrating an example of configurations of the imaging section 31 and its peripheral circuits in the light receiving device 30.

The imaging section 31 includes a pixel array section in which a plurality of pixels 51 is two-dimensionally arranged in a matrix form (an array form). In the imaging section 31, each of the plurality of pixels 51 receives incident light (e.g., near-infrared light), and performs photoelectric conversion of the incident light to output an analog pixel signal. Two vertical signal lines VSL₁ and VSL₂ are wired to each pixel column of the imaging section 31. A total of (2×M) vertical signal lines VSL is wired to the imaging section 31,where M (M is an integer) is the number of pixel columns of the imaging section 31.

Each of the plurality of pixels 51 includes a first tap A and a second tap B (to be described in detail later). An analog pixel signal AIN_{P1} based on electric charge of the first tap A of the pixel 51 in a corresponding pixel column is outputted to the vertical signal line VSL₁ of the two vertical signal lines VSL₁ and VSL₂. In addition, an analog pixel signal AIN_{P2} based on electric charge of the second tap B of the pixel 51 in the corresponding pixel column is outputted to the vertical signal line VSL₂. The analog pixel signals AIN_{P1} and AIN_{P2} are described later.

Of peripheral circuits of the imaging section 31, the pixel controller 32 is a row selector that drives the respective pixels 51 of the imaging section 31 in units of pixel rows to cause the pixels 51 to output the pixel signals AIN_{P1} and AIN_{P2}. That is, the analog pixel signals AIN_{P1} and AIN_{P2} outputted from the pixels 51 in a selected row are supplied to the column processor 34 via the two vertical signal lines VSL₁ and VSL₂ under driving by the pixel controller 32.

The column processor 34 includes a plurality of AD (analog-digital) converters 52 provided corresponding to pixel columns of the imaging section 31 (e.g., for each pixel column). In the column processor 34, the AD converters 52 each perform analog-digital conversion processing on the analog pixel signals AIN_{P1} and AIN_{P2} supplied via the vertical signal lines VSL₁ and VSL₂.

The digitalized pixel signals AIN_{P1} and AIN_{P2} outputted from the column processor 34 are supplied to the data processor 35 illustrated in FIG. 2 via the output circuit section 54. The data processor 35 performs predetermined signal processing such as CDS processing on the digitalized pixel signals AIN_{P1} and AIN_{P2}, and thereafter outputs the digitalized pixel signals AIN_{P1} and AIN_{P2} to outside of the light receiving device 30 via the output I/F 37.

The timing generator 53 generates various types of timing signals, clock signals, control signals, and the like, and controls driving of the pixel controller 32, the column processor 34, the output circuit section 54, and the like on the basis of these signals.

### [Circuit Configuration Example of Pixel]

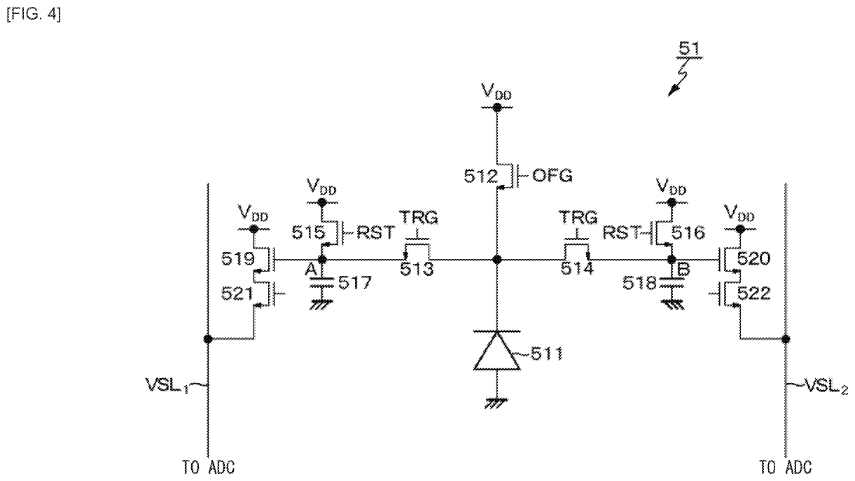

FIG. 4 is a circuit diagram illustrating an example of a circuit configuration of the pixel 51 in the imaging section 31.

The pixel 51 according to this example includes, for example, a photodiode 511 as a light receiving element (a photoelectric conversion element). The pixel 51 is configured to include an overflow transistor 512, two transfer transistors 513 and 514, two reset transistors 515 and 516, two floating diffusion layers 517 and 518, two amplification transistors 519 and 520, and two selection transistors 521 and 522 in addition to the photodiode 511. The two floating diffusion layers 517 and 518 correspond to the first and second taps A and B (hereinafter may be simply referred to as “taps A and B”) illustrated in FIG. 3 described above.

The photodiode 511 photoelectrically converts received light to generate electric charge. The photodiode 511 may have, for example, a back illuminated type pixel configuration in which light applied from back surface side of a substrate is captured. However, the pixel configuration is not limited to the back illuminated type pixel configuration, and may be a front illuminated type pixel configuration in which light applied from front surface side of a substrate is captured.

The overflow transistor 512 is coupled between a cathode electrode of the photodiode 511 and a power supply line of a power supply voltage V_{DD}, and has a function of resetting the photodiode 511. Specifically, the overflow transistor 512 is turned to an electrically conductive state in response to an overflow gate signal OFG supplied from an imaging driving section 33 to thereby sequentially discharge electric charge of the photodiode 511 to the power supply line of the power supply voltage V_{DD}.

The two transfer transistors 513 and 514 are respectively coupled between the cathode electrode of the photodiode 511 and the two floating diffusion layers 517 and 518 (the taps A and B). The transfer transistors 513 and 514 are then turned to the electrically conductive state in response to a transfer signal TRG supplied from the pixel controller 32 to respectively sequentially transfer electric charge generated by the photodiode 511 to the floating diffusion layers 517 and 518.

The floating diffusion layers 517 and 518 corresponding to the first and second taps A and B accumulate the electric charge transferred from the photodiode 511, and convert the electric charge into voltage signals having a voltage value corresponding to the amount of the electric charge to generate the analog pixel signals AIN_{P1} and AIN_{P2}.

The two reset transistors 515 and 516 are respectively coupled between the two floating diffusion layers 517 and 518 and the power supply line of the power supply voltage V_{DD}. The reset transistors 515 and 516 are then turned to the electrically conductive state in response to a reset signal RST supplied from the pixel controller 32 to respectively extract electric charge from the floating diffusion layers 517 and 518, thereby initializing the amount of electric charge.

The two amplification transistors 519 and 520 are respectively coupled between the power supply line of the power supply voltage V_{DD} and the two selection transistors 521 and 522, and respectively amplify voltage signals obtained by converting electric charge into voltages by the floating diffusion layers 517 and 518.

The two selection transistors 521 and 522 are respectively coupled between the two amplification transistors 519 and 520 and the vertical signal lines VSL₁ and VSL₂. Further, the selection transistors 521 and 522 are turned to the electrically conductive state in response to a selection signal SEL supplied from the pixel controller 32 to respectively output the voltage signals amplified by the amplification transistors 519 and 520 as analog pixel signals AIN_{P1} and AIN_{P2} to the two vertical signal lines VSL₁ and VSL₂.

The two vertical signal lines VSL₁ and VSL₂ are coupled to an input end of one AD converter 52 in the column processor 34 for each pixel column, and transmit the analog pixel signals AIN_{P1} and AIN_{P2} outputted from the pixels 51 for each pixel column to the AD converter 52.

It is to be noted that as long as the circuit configuration of the pixel 51 is a circuit configuration that is able to generate the analog pixel signals AIN_{P1} and AIN_{P2} by photoelectric conversion, the circuit configuration of the pixel 51 is not limited to the circuit configuration exemplified in FIG. 3.

### [About Calculation of Distance by Indirect ToF Scheme]

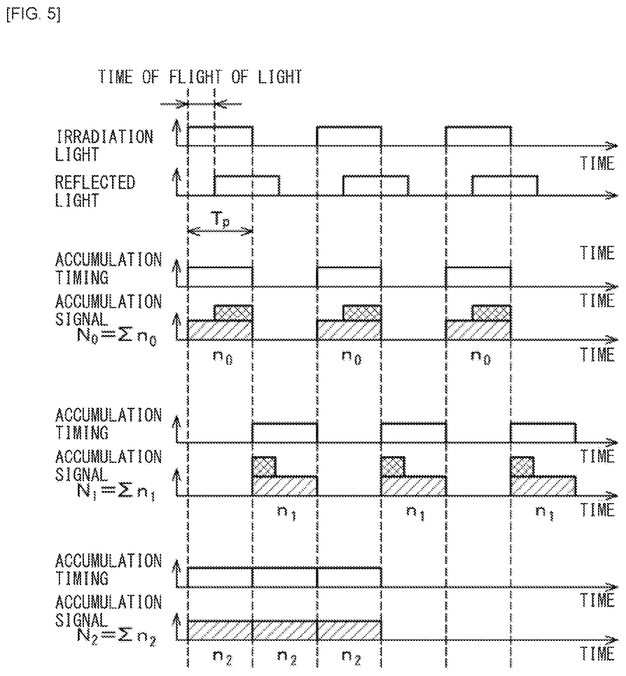

Here, description is given of calculation of a distance by the indirect ToF scheme with reference to FIG. 5. FIG. 5 is a timing waveform diagram for describing calculation of a distance by the indirect ToF scheme. The light source section 20 and the light receiving device 30 in the distance measuring device 1 illustrated in FIG. 1 operate at timings illustrated in the timing waveform diagram in FIG. 5.

The light source section 20 irradiates the distance measurement target with pulsed light during a predetermined period, e.g., only during a period of a pulsed light emission time Tₚ. The pulsed light emitted from the light source section 20 returns after being reflected by the distance measurement target. The reflected pulsed light is received by the photodiode 511. A time from start of irradiation of the distance measurement target with the pulsed light to reception of the reflected pulsed light by the photodiode 511, that is, a time of flight of light is a time corresponding to a distance from the distance measuring device 1 to the distance measurement target.

In FIG. 4, the photodiode 511 receives the reflected pulsed light from the distance measurement target only during the period of the pulsed light emission time Tₚ from a point in time when irradiation with the pulsed light starts. Upon a single time of light reception, electric charge photoelectrically converted by the photodiode 511 is transferred to and accumulated in the tap A (the floating diffusion layer 517).

Then, a signal n₀ having a voltage value corresponding to the amount of the electric charge accumulated in the floating diffusion layer 517 is obtained from the tap A. At a point in time when an accumulation timing of the tap A ends, the electric charge photoelectrically converted by the photodiode 511 is transferred to and accumulated in the tap B (the floating diffusion layer 518). Then, a signal n₁ having a voltage value corresponding to the amount of the electric charge accumulated in the floating diffusion layer 518 is obtained from the tap B.

Driving in which phases of accumulation timings are different by 180 degrees (driving in which the phases are completely opposite) is performed on the tap A and the tap B in such a manner to respectively obtain the signal n₀ and the signal n₁. Then, such driving is repeated a plurality of times, and accumulation and integration of the signal n₀ and the signal n₁ are performed to respectively acquire an accumulation signal N₀ and an accumulation signal N₁.

For example, in one pixel 51, light reception is performed twice per phase, and signals are accumulated four times in each of the tap A and the tap B. That is, signals of 0 degrees, 90 degrees, 180 degrees, and 270 degrees are accumulated in each of the tap A and the tap B. It is possible to calculate a distance D to the distance measurement target on the basis of the accumulation signal N₀ and the accumulation signal N₁ that are thus acquired.

The accumulation signal N₀ and the accumulation signal N₁ also include a component of ambient light (ambient light) reflected and scattered by an object, air, and the like, in addition to a component of reflected light (active light) that returns after being reflected by the distance measurement target. Accordingly, in an operation described above, in order to remove an influence of the component of the ambient light and leave the component of the reflected light, accumulation and integration are performed on a signal n₂ based on the ambient light to acquire an accumulation signal N₂ relating to the component of the ambient light.

It is possible to calculate the distance D to the distance measurement target by arithmetic processing based on the following expression (1) and the following expression (2) with use of the accumulation signal N₀ and the accumulation signal N₁ that each include the component of the ambient light, and the accumulation signal N₂ relating to the component of the ambient light that are thus acquired.

$$[ Math . 1 ]$$

$$Δ ϕ = \frac{{N}_{0} - {N}_{2}}{{N}_{0} + {N}_{1} - 2 \cdot {N}_{2}} \qquad ( 1 )$$

$$[ Math . 2 ]$$

$$D = \frac{c \cdot {T}_{p}}{2} ( 1 - \frac{Δϕ}{2 π} ) \qquad ( 2 )$$

In the expression (1) and the expression (2), D indicates a distance to a distance measurement target, c indicates speed of light, and Tₚ indicates a pulsed light emission time.

Arithmetic processing for calculating the distance D is executed in the application processor 40 provided outside the light receiving device 30. That is, the application processor 40 is able to calculate the distance D to the distance measurement target by the arithmetic processing based on the expression (1) and the expression (2) described above with use of the accumulation signal N₀ and the accumulation signal N₁ that each include the component of the ambient light, and the accumulation signal N₂ relating to the component of the ambient light. The application processor 40 is further able to acquire (generate) a distance map image on the basis of pixel signals for a plurality of frames outputted from the light receiving device 30.

### [About Acquirement of Image]

In the light receiving device 30 that is able to detect a distance by the indirect ToF scheme described above, the configuration of the pixel 51 illustrated in FIG. 4 is the same as the configuration of a pixel of a normal CMOS image sensor, except that electric charge is separated into the tap A and the tap B. Accordingly, imaging is performed not by irradiation with pulsed light from the light source section 20 nor by pulsed light in a predetermined cycle, but in a continuous light emission state, which makes it possible to acquire a monochrome image by the light receiving device 30.

### [About Power Consumption of Distance Measuring Device]

Incidentally, in the distance measuring device 1 having the configuration described above, a technology is necessary that detects a condition such as approach of an object and automatically starts up the entire system only in a case where processing is necessary. In a case where it is desired to perform automatic startup, the light source section 20 and the light receiving device 30 are controlled from the application processor 40; therefore, it is necessary to always make the application processor 40 active. In addition, in a case where detection of approach of an object or the like is performed in the light receiving device 30, electric power is constantly consumed by the light source section 20 and the light receiving device 30; therefore, power consumption of the entire distance measuring device 1 is a significant issue.

### EMBODIMENTS OF PRESENT DISCLOSURE

For this reason, in an embodiment of the present disclosure, an automatic startup mechanism for detecting that an object (a subject) approaches within a predetermined distance and starting up the entire system of the distance measuring device 1 only in a case where processing is necessary is achieved in the light receiving device 30. Specifically, object detection for automatic startup, that is, detection of a condition such as approach of an object is performed in the light receiving device 30 by simple distance measurement, and notification of a result of the detection is provided to the application processor 40, and switching of an internal status of the light receiving device 30 or switching of a status of the light source section 20 is performed on the basis of the result of the detection. The application processor 40 starts up in response to the notification from the light receiving device 30.

Here, description is given of the simple distance measurement. It is possible to mount the distance measuring device 1 on, for example, a mobile device such as a smartphone for use of face authentication or the like. For example, in an example of a smartphone, it is sufficient if it is found that an object (a human face) is present at an approximate distance (e.g., about 20 cm to about 80 cm). Accordingly, it is not necessary to acquire a high-resolution distance map image of an entire subject, and simplified distance measurement, that is, simple distance measurement is sufficient for object detection for automatic startup.

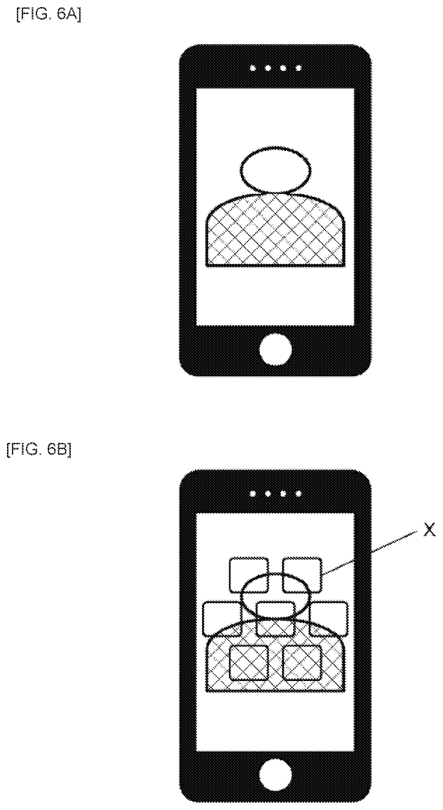

In normal distance measurement, a high-resolution distance map image is calculated (acquired) from distance information of each of the pixels in an entire screen illustrated in FIG. 6A. In contrast, in the simple distance measurement, information for one point is acquired by selecting one to several pixels from the entire screen, or by processing such as a combination of pixel addition (binning) and thinning in a square-shaped region X (one to several regions) as illustrated in FIG. 6B. Reducing the number of information acquirement points for the simple distance measurement makes it possible to achieve the simple distance measurement in the light receiving device 30 without need for a large-scale circuit.

Achieving the automatic startup mechanism in the light receiving device 30 makes it possible to keep the application processor 40 in a standby state without need to constantly keep the application processor 40 in an active state. This makes it possible to reduce power consumption of the application processor 40, or by extension of the entire distance measuring device 1. In addition, the light receiving device 30 frequently performs switching of the status of the light source section 20 in real time according to control by the light receiving device 30, which makes it possible to further reduce power consumption. In addition, application of a result of the simple distance measurement in the light receiving device 30 makes it possible to achieve reduction in power consumption when the application processor 40 uses another functional section.

Hereinafter, description is given of specific examples for reduction in power consumption of the distance measuring device 1 according to the embodiment of the present disclosure.

### EXAMPLE 1

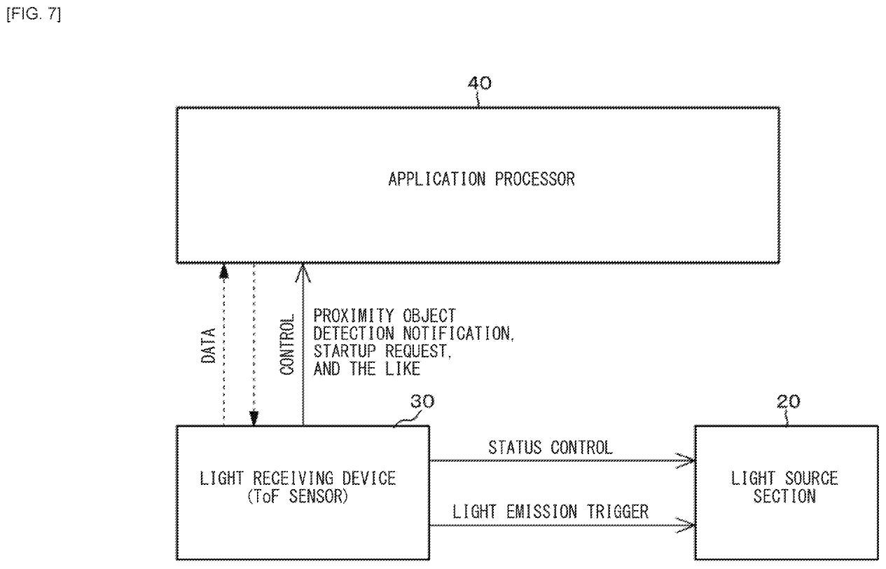

Example 1 is an example of a light receiving device (a ToF sensor) that is able to perform monitoring of a startup timing and startup notification in a stand-alone manner with low power consumption. FIG. 7 illustrates an example of a basic system configuration of the distance measuring device 1 according to Example 1. In FIG. 7, a specific internal configuration of the light receiving device 30 is the same as the configuration of the light receiving device 30 in FIG. 2.

In FIG. 7, a solid arrow indicates control during system standby, and a dotted arrow indicates an operation only during system startup. The control during system standby includes proximity object detection notification (interruption), startup request, and the like from the light receiving device 30 to the application processor 40, and includes status control and a light emission trigger from the light receiving device 30 to the light source section 20. The control during system startup includes data exchange between the light receiving device 30 and the application processor 40.

Respective functions of the light source section 20, the light receiving device 30, and the application processor 40 in the distance measuring device 1 according to Example 1 are as follows.

Functions necessary for the light source section 20 include functions of a status switchable in accordance with a mode and an external control interface (I/F). Having these functions makes it possible for the light source section 20 to operate with low power consumption except for during laser light emission.

The light receiving device 30 needs the following functions.
(1) Performing proximity object detection in a stand-alone manner, that is, enabling the simple distance measurement in the light receiving device 30. This function is a function of the proximity object detector 36 in FIG. 2.
(2) Having a function of notifying the application processor 40 or the outside upon proximity object detection.
(3) Enabling driving with low power consumption during a proximity object detection operation in the proximity object detector 36. This is achievable by putting internal blocks on standby except for during proximity object detection, stopping operations of unnecessary circuits, turning the light source section 20 to a standby state with the operation of the light receiving device 30, or driving the light source section 20 with low power consumption. Driving the light source section 20 with low power consumption is achievable by lowering the light emission frequency or reducing the light emission amount (a current).

Functions necessary for the application processor 40 include a function of returning from a sleep state in response to interruption from the light receiving device 30.

According to the distance measuring device 1 according to Example 1 having the configuration described above, using the functions of the light source section 20 and the light receiving device 30 without using the application processor 40 makes it possible to perform simple distance measurement for detecting a condition such as approach of an object.

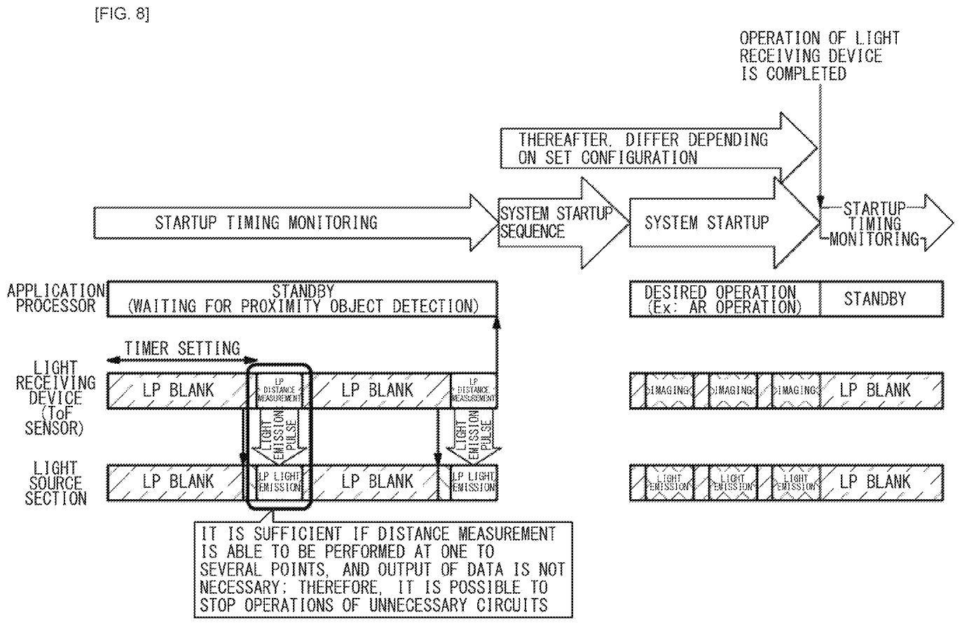

FIG. 8 illustrates a sequence image of the distance measuring device 1 according to Example 1. A sequence of the distance measuring device 1 is “startup timing monitoring”→“system startup sequence”→“system startup”, and the operation of the light receiving device 30 is completed at a system startup timing.

It is to be noted that in FIG. 8, “LP” means low power consumption (Low Power) as compared with power consumption during normal imaging, and “blank” indicates a blanking period (the standby state). Hereinafter, the blanking period with low power consumption is referred to as “LP blank”, and simple distance measurement with low power consumption is referred to as “LP distance measurement”.

The light receiving device 30 includes a timer for startup (corresponding to a timer included in the proximity object detection timing generator 44 in FIG. 2) inside, and manages a timing of performing proximity object detection, and performs startup of itself and the light source section 20, the simple distance measurement, and notification to the application processor 40 upon proximity object detection. The light receiving device 30 knows the startup timing, which makes it possible to stop blocks in the light receiving device 30 and the light source section 20 that takes time to start up and achieve reduction in power consumption.

The light receiving device 40 performs startup of itself and the light source section 20 with start of the proximity object detection operation. In the simple distance measurement, it is sufficient if distance measurement is able to be performed at one to several points, and output of data is not necessary; therefore, it is possible to stop operations of circuits that are not necessary for the simple distance measurement. Stopping the operations of the circuits that are not necessary for the simple distance measurement makes it possible to achieve reduction in power consumption of the light receiving device 30, or by extension of the entire distance measuring device 1. In addition, at least one of the frequency or the light emission amount of pulsed light emitted from the light source section 20 is variable, and the light emission frequency and the light emission amount of the pulsed light are decreased in accordance with a target for the simple distance measurement, as compared with a case of distance measurement for acquiring a distance map image, which also makes it possible to reduce power consumption.

The sequence image in FIG. 8 is a sequence in which proximity object detection is not performed in first simple distance measurement, and proximity object detection is performed in second simple distance measurement. The light receiving device 30 notifies the application processor 40 of proximity object detection only in a case where a proximity object is detected, and starts up the system. By startup of the system, the application processor 40 performs a desired operation, e.g., processing such as AR (Augmented Reality: augmented reality), and shifts to the standby state at a timing at which the operation of the light receiving device 30 is completed.

Here, description is given of activated block images in respective states in respective functional blocks of the distance measuring device 1 illustrated in FIG. 2, or specifically, an “LP blank” state, an “LP distance measurement” state, and an “imaging” state.

### (“LP Blank” State)

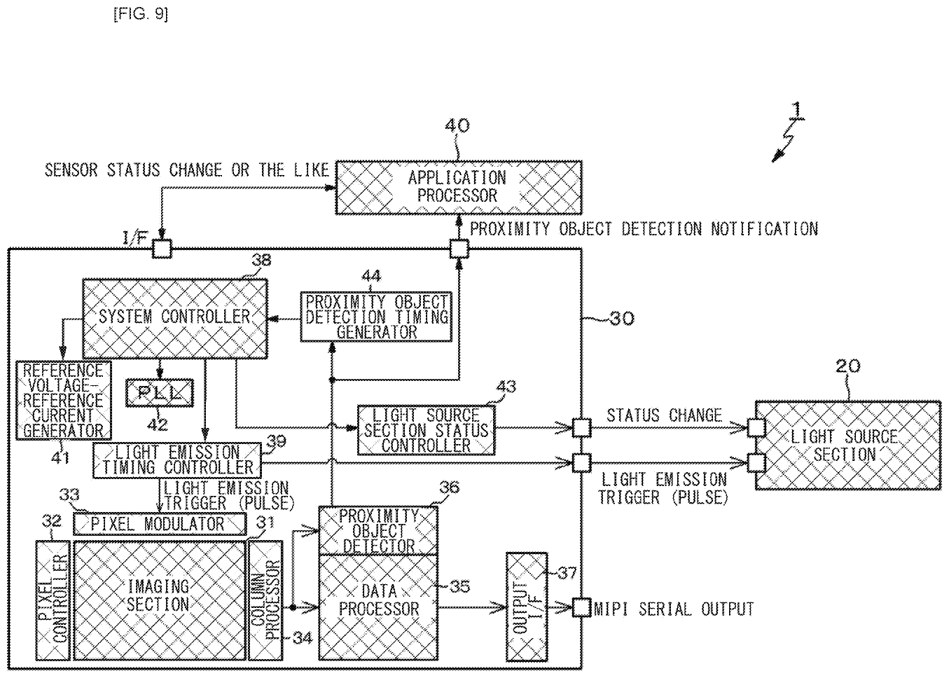

FIG. 9 illustrates the activated block image in the “LP blank” state. In FIG. 9, an activated block is illustrated as a hollow block, and a deactivated block is illustrated as a shaded block. In the “LP blank” state, the light source section 20 and the application processor 40 are in a deactivated state.

In addition, in the light receiving device 30, only the proximity object detection timing generator 44 is in an activated state. Specifically, in the proximity object detection timing generator 44, in the “LP blank” state, only the timer for startup is in an operation state. It is to be noted that in the data processor 35, electric power supply may be shut off at a point where a leakage current is high, e.g., a logic processing point.

As described above, the light source section 20 and the application processor 40, and blocks of the light receiving device 30 except for the proximity object detection timing generator 44 are turned to the deactivated state, which makes it possible to achieve reduction in power consumption in the “LP blank” state.

### (“LP Distance Measurement” State)

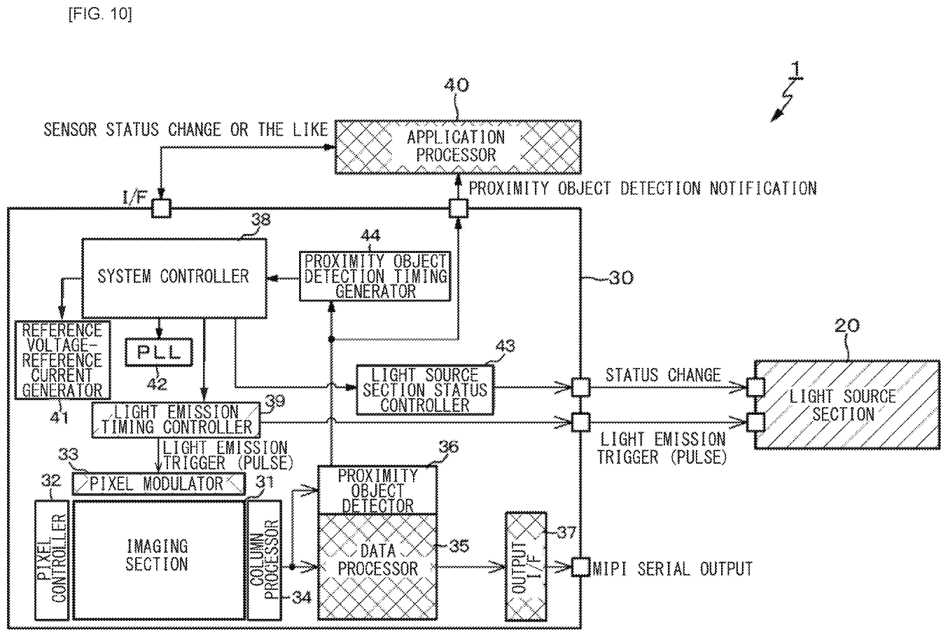

FIG. 10 illustrates the activated block image in the “LP distance measurement” state. In FIG. 10, an activated block is illustrated as a hollow block, and a deactivated block is illustrated as a shaded block. In the “LP distance measurement” state, the application processor 40 and some blocks of the light receiving device 30 are in the deactivated state.

In the LP distance measurement (simple distance measurement), distance calculation is performed with use of pixel signals in a partial region of the imaging section 31; therefore, the pixel modulator 33 and the column processor 34 in the light receiving device 30 are turned to the operation state, but operations of circuits that do not read the pixel signals stop. That is, a circuit portion not relating to reading of the pixel signals of the pixel modulator 33, a circuit portion not relating to reading of the pixel signals of the column processor 34, the data processor 35, and the output I/F 37 are turned to the deactivated state, and other circuits are turned to the activated state. It is to be noted that operations of the light source section 20 of which power consumption is large, and the light emission timing controller 39 that operates at a high frequency may be limited.

In the “LP distance measurement” state, the proximity object detector 36 performs arithmetic processing for distance measurement on data compressed into one to several pixels by processing for adding pixel signals of peripheral pixels, or the like.

### (“Imaging” State)

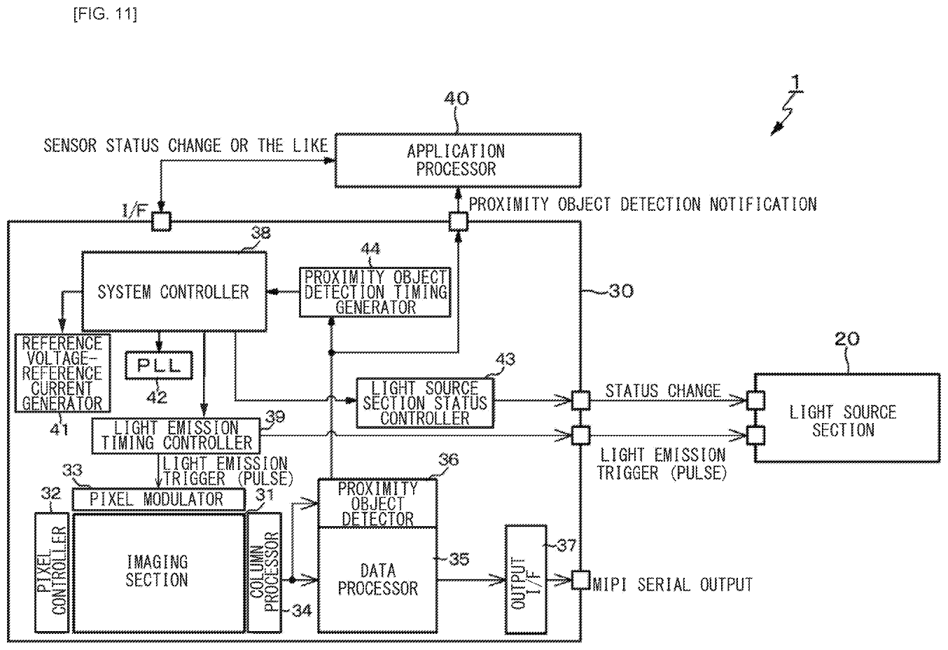

FIG. 11 illustrates the activated block image in the “imaging” state. As illustrated by hollow blocks in FIG. 11, in the “imaging” state, the light source section 20, the application processor 40, and all blocks of the light receiving device 30 are in the activated state. Then, in the “imaging” state in which a distance map image is acquired, in order to increase accuracy of imaging, the light source section 20 is set to a large light amount, and the light emission timing controller 39 of the light receiving device 30 is set at a high frequency.

### EXAMPLE 2

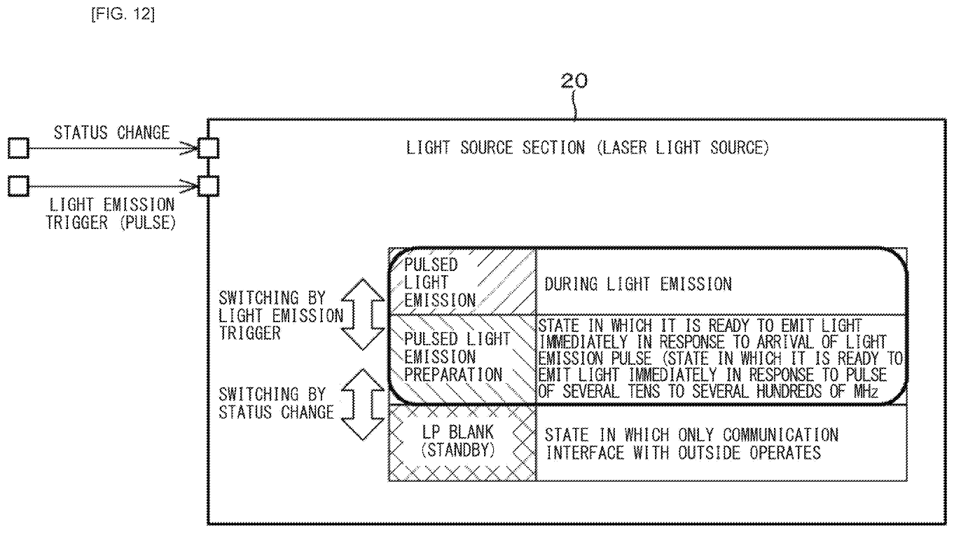

Example 2 is a configuration example of the light source section 20 in the distance measuring device 1 according to Example 1. FIG. 12 illustrates an image in the operation mode of the light source section 20 according to Example 2.

The light source section 20 according to Example 2 needs the following functions.
(1) Having a state in which unnecessary power consumption does not occur when emission of pulsed light is not necessary.
(2) Having a state in which it is possible to emit light in accordance with a high-frequency light emission request (light emission pulse).
(3) Having a state in which the light emission amount (an output current) is adjustable in accordance with a necessary light amount.
(4) Having a communication interface that dynamically switches (1) to (3) described above.

Accordingly, the light source section 20 according to Example 2 has respective operation modes of pulsed light emission, pulsed light emission preparation, and LP blank (standby). Then, switching between the mode of pulsed light emission and the mode of pulsed light emission preparation is performed by a light emission trigger transmitted from the light receiving device 30 by a pulse. In addition, switching between the mode of pulsed light emission preparation and the mode of LP blank is performed by a control signal for status change transmitted from the light receiving device 30 via an interface such as an I2C/SPI or via a control line.

The mode of pulsed light emission is a mode of a state in which pulsed light is being emitted, and the mode of pulsed light mission preparation is a mode of a state in which it is ready to emit light immediately after arrival of the light emission trigger, or specifically, a mode of a state in which it is ready to emit light immediately in response to a pulse of several tens of MHz to several hundreds of MHz. Upon the simple distance measurement and imaging, it is ready to immediately emit light in the mode of pulsed light emission preparation, and switching to the mode of pulsed light emission is performed after arrival of the light emission trigger. The modes of pulsed light emission preparation and LP blank are modes that are to be set after the simple distance measurement or imaging, and are modes with extremely low power consumption in which only the communication interface with the outside operates.

In the light source section 20 having the configuration described above, light emission intensity (a driver voltage) is variable, and in the “LP distance measurement” state in which the simple distance measurement is performed, an output current is suppressed as compared with a “light emission” state during normal distance measurement for acquiring a distance map image to decrease light emission intensity, which makes it possible to further reduce power consumption in the “startup timing monitoring” in the sequence image in FIG. 8.

### EXAMPLE 3

Example 3 is an example of a proximity object detection sequence in the distance measuring device 1 according to Example 1. Processing of the proximity object detection sequence is executed in the light receiving device 30 by issuing a startup monitoring request from the application processor 40 to the light receiving device 30. It is to be noted that the application processor 40 is turned to the sleep state after issuing the startup monitoring request.

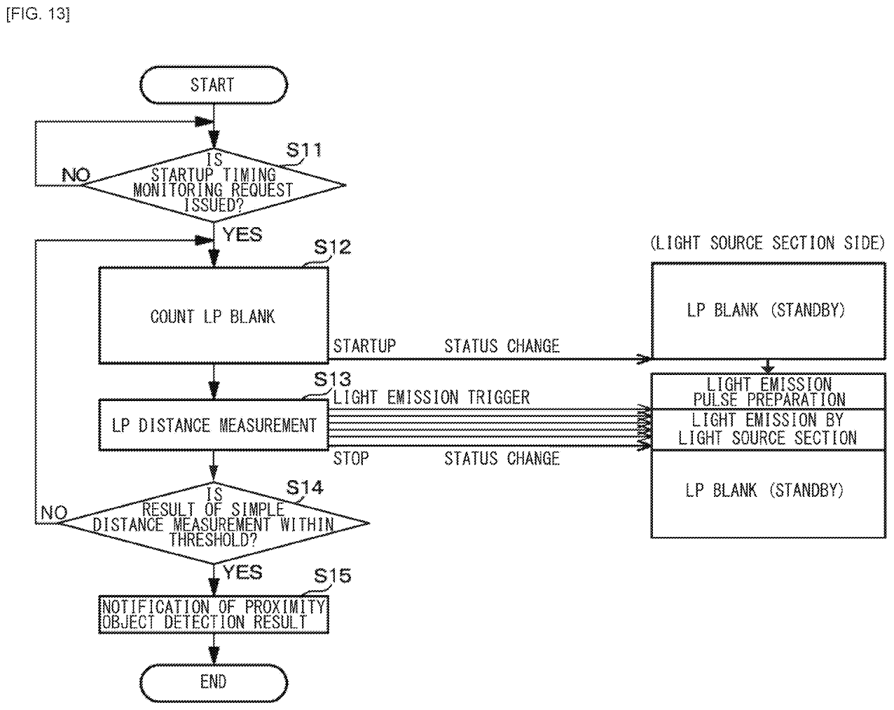

An example of a flow of processing of the proximity object detection sequence according to Example 3 is illustrated in a flowchart in FIG. 13. The processing of the proximity object detection sequence is executed, for example, by controlling respective functional blocks in the light receiving device 30 by the system controller 38 configured with use of a CPU in FIG. 2.

The system controller 38 waits for generation of the startup monitoring request from the application processor 40 (step S11), and in a case where the startup monitoring request is issued (YES in S11), the system controller 38 counts a blanking period of the LP blank, starts up after a lapse of the blanking period, and makes a request for status change to the light source section 20 in the standby state (step S12).

Next, the system controller 38 executes LP distance measurement (simple distance measurement) in which distance measurement is performed on the basis of pixel signals in a partial region of a pixel region of the imaging section 31 (step S13). In the “LP distance measurement” state, the light emission trigger is provided from the light emission timing controller 39 to the light source section 20. In addition, the light source section 20 stops after the LP distance measurement ends, and a request for status change is made from the light receiving device 30 to the light source section 20. In response to the request for status change, the light source section 20 is turned to the LP blank (standby state) state.

Next, the system controller 38 determines whether or not a result of the simple distance measurement falls within a predetermined threshold (step S14), and returns to the step S12 in a case where the result is not within the predetermined threshold (NO in S14). Here, the predetermined threshold is a detection condition for detecting a proximity object, and is, for example, a preset distance. In a case where the result of the simple distance measurement is within the predetermined threshold (YES in S14), it means that the proximity object has been detected; therefore, the system controller 38 outputs notification of proximity object detection to the application processor 30 in the sleep state (step S15), and ends a series of processing of the proximity object detection sequence.

### EXAMPLE 4

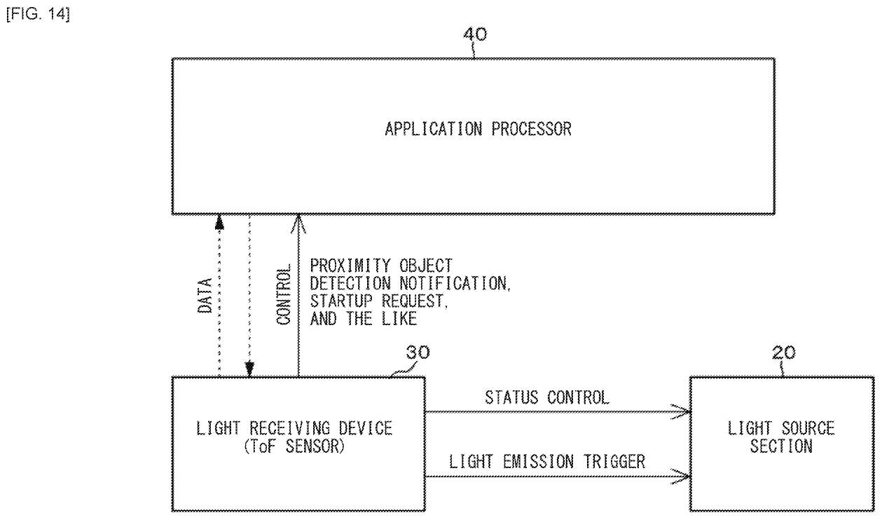

Example 4 is an example of a light receiving device (a ToF sensor) that is able to perform startup timing monitoring, face detection and face authentication, and startup notification in a stand-alone manner with low power consumption. It is to be noted that for face detection and face authentication, a configuration including impersonation confirmation may be adopted, or a configuration including only face detection without face authentication may be adopted. FIG. 14 illustrates an example of a basic system configuration of the distance measuring device 1 according to Example 4.

In FIG. 14, a solid arrow indicates control during system standby, and a dotted arrow indicates control during system startup. The control during system standby includes proximity object detection notification (interruption), startup request, and the like from the light receiving device 30 to the application processor 40, and includes status control and a light emission trigger from the light receiving device 30 to the light source section 20. The control during system startup includes data exchange between the light receiving device 30 and the application processor 40.

Respective functions of the light source section 20, the light receiving device 30, and the application processor 40 in the distance measuring device 1 according to Example 4 are as follows.

Functions necessary for the light source section 20 include functions of a status switchable in accordance with a mode and an external control interface (I/F). Having these functions makes it possible for the light source section 20 to operate with low power consumption except for during laser light emission. In addition to these functions, the light source section 20 in the distance measuring device 1 according to Example 4 has a constant irradiation status with low power consumption for face detection and face authentication.

The light receiving device 30 needs the following functions.
(1) Performing proximity object detection in a stand-alone manner, that is, enabling the simple distance measurement in the light receiving device 30. This function is a function of the proximity object detector 36 in FIG. 2.
(2) Having a function of notifying the application processor 40 or the outside upon proximity object detection.
(3) Enabling driving with low power consumption during a proximity object detection operation in the proximity object detector 36. This is achievable by putting internal blocks on standby except for during proximity object detection, stopping operations of unnecessary circuits, turning the light source section 20 to a standby state with the operation of the light receiving device 30, or driving the light source section 20 with low power consumption. Driving the light source section 20 with low power consumption is achievable by lowering the light emission frequency or reducing the light emission amount (a current).
(4) Having a face detection function, a face authentication function, and an impersonation confirmation function (having only the face detection function is sufficient).

Here, face detection, face authentication (face recognition), and impersonation confirmation are achievable with use of known technologies. For example, performing imaging in a continuous light emission state makes it possible to acquire an image by the light receiving device 30, which makes it possible to perform detection of a face at a specific position on the basis of the image. For face authentication, it is possible to use a pattern recognition technology by machine learning such as a neural network, e.g., a technology in which recognition processing is performed by comparing a feature point of a face supplied as teacher data (master data for matching) with a feature point of a captured face image (a distance map image). In addition, it is possible to perform impersonation confirmation by detecting facial irregularities on the basis of the image and comparing the facial irregularities with preregistered data.

Functions necessary for the application processor 40 include a function of returning from the sleep state in response to interruption from the light receiving device 30.

According to the distance measuring device 1 according to Example 4 having the configuration described above, in a case of a system for unlocking with face authentication or the like, not only detection of a proximity object but also face detection and face authentication are performed in the light receiving device 30, and notification is provided to the application processor 40 upon face detection or upon face authentication, which makes it possible to construct a system with lower power consumption and a low load on the application processor 40. At this time, the light source section 20 has a function of operating with low power consumption in constant irradiation, which makes it possible to control face detection with use of IR (Infrared: infrared) light by the light source section 20 and the light receiving device 30.

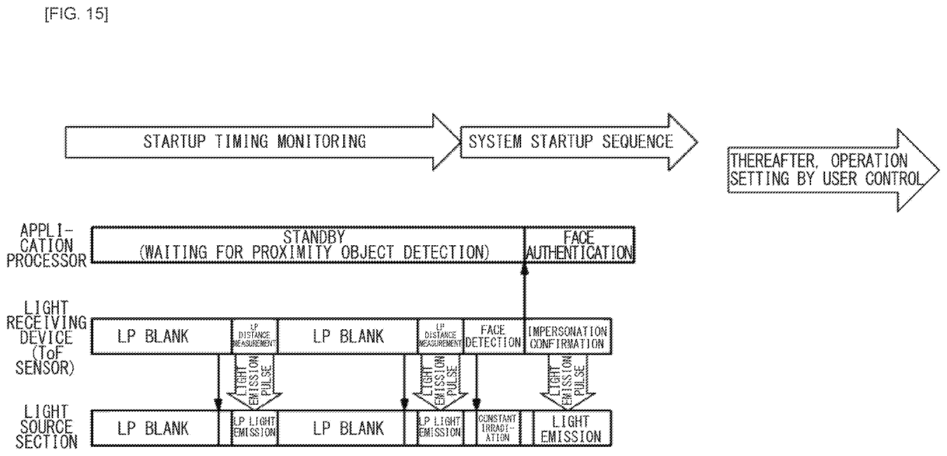

FIG. 15 illustrates a sequence image of the distance measuring device 1 according to Example 4. A sequence of the distance measuring device 1 is “startup timing monitoring” “system startup sequence”, and after the sequence, operation setting is performed by user control.

In a case of processing of face detection and impersonation confirmation, it is necessary to acquire an image in the light receiving device 30; therefore, the light source section 20 does not need high-speed irradiation, and operates in a constant irradiation mode. In addition, in processing of impersonation confirmation, it is necessary to detect facial irregularities; therefore, the light receiving device 30 performs distance measurement with high accuracy. After detecting a face, the light receiving device 30 notifies the application processor 40 that the face is detected. In response to such notification, the application processor 40 in the standby state starts up, and performs face authentication on the basis of a distance map image.

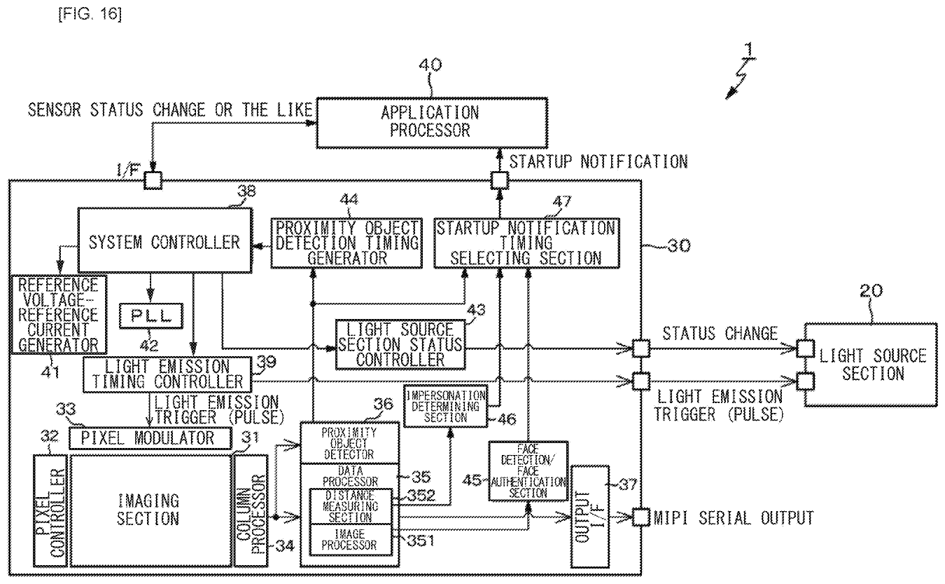

FIG. 16 illustrates an example of a configuration of the light receiving device 30 in the distance measuring device 1 according to Example 4. The light receiving device 30 exemplified here has a configuration having a function of performing face authentication inside.

In the light receiving device 30, the data processor 35 is configured to include functional sections of an image processor 351 and a distance measuring section 352 that perform processing for face detection, face authentication, and impersonation confirmation with use of pixel signals outputted from the imaging section 31. The image processor 351 performs processing for acquiring an image on the basis of pixel signals outputted from the imaging section 31. Detection of facial irregularities is performed in impersonation confirmation; therefore, the distance measuring section 352 performs distance measurement with high accuracy.

The light receiving device 30 includes a face detection/face authentication section 45 for performing processing of face detection and face authentication, and an impersonation determining section 46 for performing processing of impersonation confirmation. The face detection/face authentication section 45 performs processing for face detection and face authentication (e.g., processing described above) on the basis of the image acquired by the image processor 351. The impersonation determining section 46 detects facial irregularities on the basis of a result of distance measurement by the distance measuring section 352 to thereby perform processing for impersonation confirmation.

The light receiving device 30 further includes a startup notification timing selecting section 47 that provides startup notification to the application processor 40. The startup notification timing selecting section 47 provides the startup notification to the application processor 40 in response to a result of detection by the proximity object detector 36, a result of authentication by the face detection/face authentication section 45, or a result of determination by the impersonation determining section 46.

In the light receiving device 30, the system controller 38 is configured with use of, for example, a CPU, and performs communication and control of the entire system of the light receiving device 30, startup and stop sequence control, status control, and the like. Statuses controlled by the system controller 38 include statuses of face detection (an image), face authentication (an image), and impersonation confirmation (face determination by distance measurement). In addition, control by the system controller 38 also includes control of the light emission amount of the light source section 20, switching of the light emission frequency, and the like.

It is to be noted that here, as the light receiving device 30, a configuration having the functions of face detection, face authentication, and impersonation confirmation is described as an example; however, a configuration that does not necessarily have these three functions may be adopted. However, a configuration having the function of face authentication is essential. In a case of the configuration having only the function of face authentication, the distance measuring section 352 may be configured to be provided outside the light receiving device 30.

### EXAMPLE 5

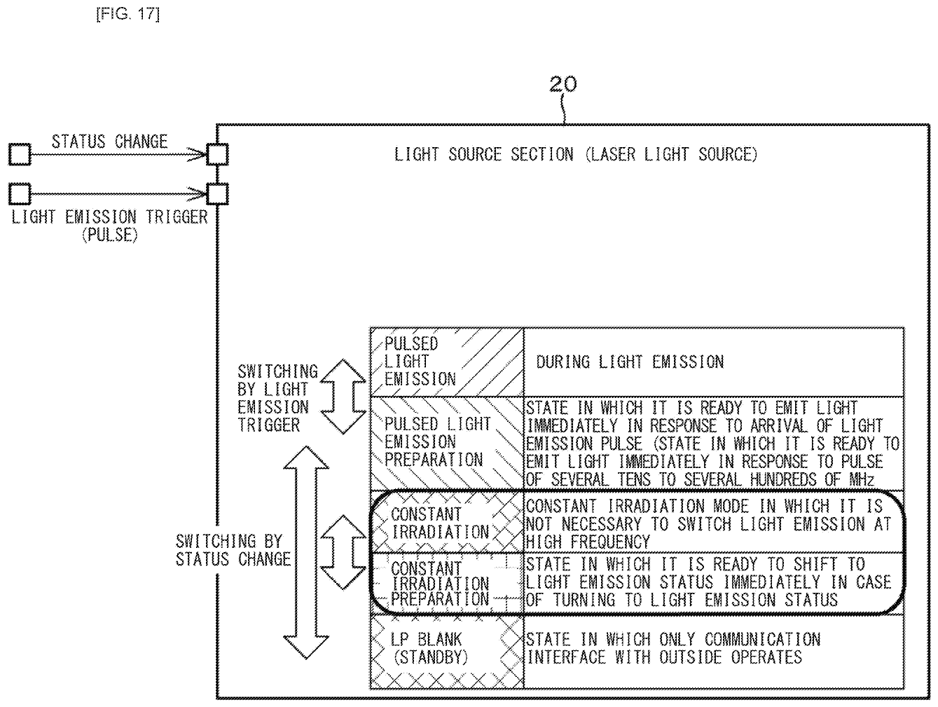

Example 5 is a configuration example of the light source section 20 in the distance measuring device 1 according to Example 4. FIG. 17 illustrates an image of the operation mode of the light source section 20 according to Example 5.

The light source section 20 according to Example 5 needs the following functions.
(1) Having a state in which unnecessary electric power is not applied when light emission is not necessary.
(2) Having a state in which it is possible to emit light in accordance with a high-frequency light emission request (light emission pulse).
(3) Having a state of not flashing but constant irradiation.
(4) Having a function of being able to adjust the light emission amount (an output current) in accordance with a necessary light amount.
(5) Having a communication interface that dynamically switches (1) to (4) described above.

Accordingly, the light source section 20 according to Example 5 has respective operation modes of pulsed light emission, pulsed light emission preparation, constant irradiation, constant irradiation preparation, and LP blank (standby). Then, switching between the mode of pulsed light emission and the mode of pulsed light emission preparation is performed by a light emission trigger transmitted from the light receiving device 30 by a pulse. In addition, switching between the mode of constant irradiation and the mode of constant irradiation preparation, and switching between the mode of pulsed light emission preparation and the mode of LP blank are performed by a control signal for status change transmitted from the light receiving device 30 via an interface such as an I2C/SPI or via a control line.

The mode of pulsed light emission is a mode of a state in which pulsed light is being emitted, and the mode of pulsed light emission preparation is a mode of a state that it is ready to emit light immediately after arrival of the light emission trigger, or specifically, a mode of a state in which it is ready to emit light immediately in response to a pulse of several tens MHz to several hundreds of MHz. The mode of constant irradiation is a mode in which it is not necessary to switch light emission at a high frequency, and the mode of constant irradiation preparation is a mode of a state in which it is ready to shift to a light emission status immediately after turning to the light emission status. The mode of LP blank is a mode with extremely low power consumption in which only the communication interface with the outside operates.

In face detection, it is sufficient if image accuracy (resolution) is low, and in face authentication, high image accuracy, that is, a high-resolution image is necessary. Accordingly, in the modes of constant irradiation and constant irradiation preparation, a light emission current is adjustable in accordance with the light amount of irradiation light. This makes it possible to drive the light source section 20 with low power consumption.

### EXAMPLE 6

Example 6 is an example of proximity object detection and face detection sequence in the distance measuring device 1 according to Example 4. Processing of the proximity object detection and face detections sequence is executed in the light receiving device 30 by issuing a startup monitoring request from the application processor 40 to the light receiving device 30. It is to be noted that the application processor 40 is turned to the sleep state after issuing the startup monitoring request.

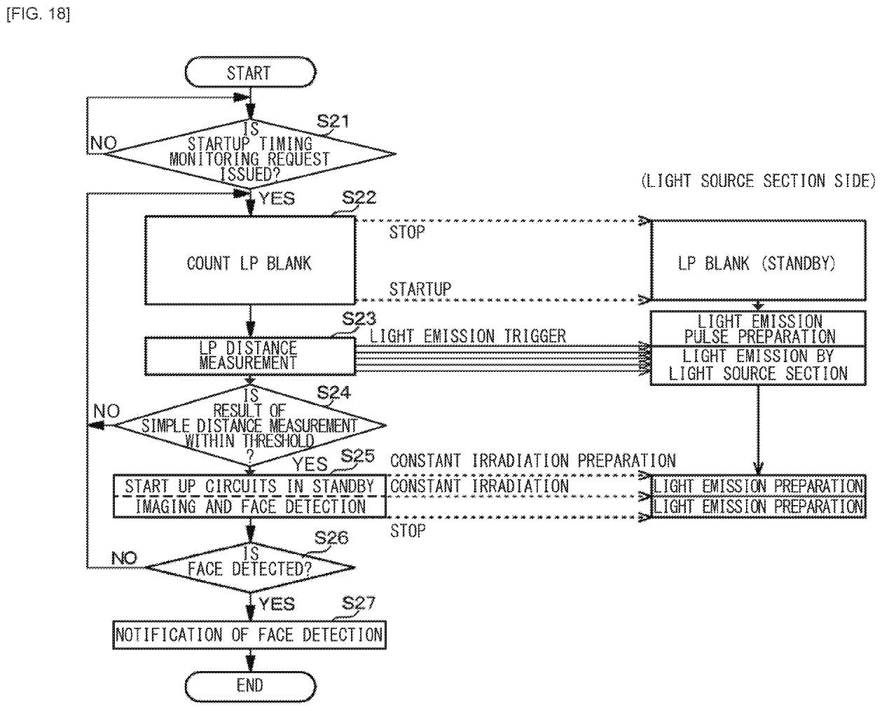

An example of a flow of processing of the proximity object detection and face detection sequence according to Example 6 is illustrated in a flowchart in FIG. 18. The processing of the proximity object detection and face detection sequence is executed, for example, by controlling respective functional blocks in the light receiving device 30 by the system controller 38 configured with use of a CPU in FIG. 2.

The system controller 38 waits for generation of the startup monitoring request from the application processor 40 (step S21), and in a case where the startup monitoring request is issued (YES in S21), the system controller 38 counts a blanking period of the LP blank, starts up after a lapse of the blanking period, and makes a request for status change to the light source section 20 in the standby state (step S22).

Next, the system controller 38 executes LP distance measurement (simple distance measurement) in which distance measurement is performed on the basis of pixel signals in a partial region of the pixel region of the imaging section 31 (step S23), and then determines whether or not a result of the simple distance measurement falls within a predetermined threshold (step S24), and returns to the step S22 in a case where the result is not within the predetermined threshold (NO in S24). Here, the predetermined threshold is a detection condition for detecting a proximity object, and is, for example, a preset distance.

In a case where the result of the simple distance measurement is within the predetermined threshold (YES in S24), the system controller 38 starts up circuits in the standby state and performs imaging and face detection (step S25). Next, the system controller 38 determines whether or not a face is detected (step S26), and in a case where the face is not detected (NO in S26), the system controller 38 returns to the step S22, and in a case where the face is detected (YES in S26), the system controller 38 outputs, to the application processor 40, notification that the face is detected (step S27), and ends a series of processing of the proximity object detection and face detection sequence.

### MODIFICATION EXAMPLES

Although the technology of the present disclosure has been described with reference to preferred embodiments, the technology of the present disclosure is not limited to the embodiments. The configurations and structures of the distance measuring device described in the above embodiments are illustrative, and may be appropriately modified.

For example, in the embodiments described above, the distance measuring device that adopts the indirect ToF scheme has been described as an example; however, ToF scheme is not limited to the indirect ToF scheme, and it is possible to adopt a direct (direct) ToF scheme in which a distance to a subject (a distance measurement target) is directly calculated from a difference in time of flight of light. In addition, on the assumption of startup upon scene change, not the proximity object detection function but a moving object detection function may be used as startup timing monitoring.

### <Electronic Apparatus of Present Disclosure>

The distance measuring device of the present disclosure described above is usable, for example, as a distance measuring device mounted on any of various electronic apparatuses. Examples of the electronic apparatuses equipped with the distance measuring device may include mobile devices such as a smartphone, a digital camera, a tablet, and a personal computer. However, the electronic apparatuses are not limited to the mobile devices. Here, a smartphone is exemplified as a specific example of an electronic apparatus (an electronic apparatus of the present disclosure) that is able to be equipped with the distance measuring device including the light receiving device of the present disclosure.

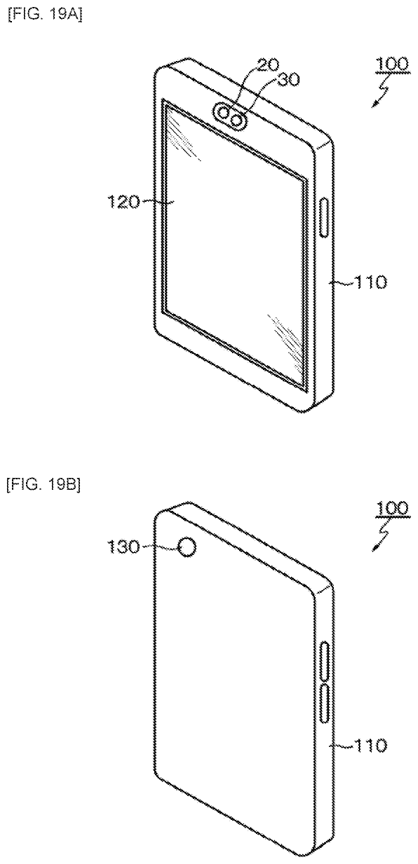

FIG. 19A illustrates an external view of the smartphone according to the specific example of the electronic apparatus of the present disclosure as viewed from front side, and FIG19B is an external view of the smartphone as viewed from back side. A smartphone 100 according to this specific example includes a display section 120 on front side of a housing 110. Further, the smartphone 100 includes an imaging section 130 in an upper section on back side of the housing 110.

It is possible to mount the distance measuring device 1 according to the embodiment of the present disclosure described above on the smartphone 100 as an example of the mobile device having the configuration described above for use. In this case, it is possible to dispose the light source section 20 and the light receiving device 30 of the distance measuring device 1 above the display section 120 as illustrated in FIG. 19A, for example. However, a disposition example of the light source section 20 and the light receiving device 30 illustrated in FIG. 19A is only an example, and disposition of the light source section 20 and the light receiving device 30 is not limited thereto.

As described above, the smartphone 100 according to this specific example is fabricated by being equipped with the distance measuring device 1 including the light receiving device 30 of the present disclosure. Further, the smartphone 100 according to this specific example is equipped with the distance measuring device 1 described above, which makes it possible to acquire a distance map image. Accordingly, it is possible to apply the smartphone 100 to a face authentication system.

In addition, the smartphone 100 is equipped with the distance measuring device 1 described above, which makes it possible to provide, for example, a way of usage such as detecting approach of a user's ear to the smartphone 100 in a case where a user makes a voice call and turning off a touch panel display. This makes it possible to reduce power consumption of the smartphone 100 and prevent a malfunction of the touch panel display. In addition, the distance measuring device 1 described above is able to achieve reduction in power consumption, which makes it possible to further reduce power consumption of the smartphone 100.

### <Possible Configurations of Present Disclosure>

It is to be noted that the present disclosure may also have the following configurations.

<<A. Distance Measuring Device>>

### [A-1]

A distance measuring device including:

a light source section that irradiates a subject with light;

a light receiving device that receives reflected light from the subject; and

an application processor that controls the light source section and the light receiving device, in which

the light receiving device has an object detection function of measuring a distance to the subject to detect that the subject approaches within a predetermined distance, and provide notification of a detection result to the application processor in a standby state, and

the application processor starts up in response to the notification from the light receiving device.

### [A-2]

The distance measuring device according to [A-1], in which the light receiving device performs switching of an internal status of the light receiving device on the basis of the detection result.

### [A-3]

The distance measuring device according to [A-2], in which the light receiving device performs switching of a status of the light source section on the basis of the detection result.

### [A-4]

The distance measuring device according to any one of [A-1] to [A-3], in which the light receiving device includes an imaging section including pixels that are arranged and each include a light receiving element, and performs simple distance measurement in which a distance is measured with use of pixel signals in a partial region within a pixel region of the imaging section.

### [A-5]

The distance measuring device according to [A-4], in which

the light source section irradiates the subject with pulsed light to be emitted in a predetermined cycle, and

the light receiving device performs the simple distance measurement by receiving reflected pulsed light from the subject and measuring a time of flight of light from a phase difference between a light emission cycle and a light reception cycle.

### [A-6]

The distance measuring device according to [A-5], in which in the light source section, at least one of a frequency or a light emission amount of the pulsed light to be emitted is variable, and at least one of the frequency or the light emission amount of the pulsed light is decreased in the simple distance measurement as compared with a case of distance measurement for acquiring a distance map image.

### [A-7]

The distance measuring device according to any one of [A-1] to [A-6], in which the light receiving device performs imaging in a continuous light emission state, thereby allowing for acquirement of an image.

### [A-8]

The distance measuring device according to [A-7], in which the light receiving device performs face detection on the basis of an acquired image.

### [A-9]

The distance measuring device according to [A-8], in which the light receiving device performs impersonation confirmation by detecting facial irregularities on the basis of the acquired image and comparing the facial irregularities with preregistered data.

### [A-10]

The distance measuring device according to [A-8], in which the application processor performs face authentication on the basis of a distance map image in response to notification of face detection from the light receiving device.

<<B. Method of Controlling Distance Measuring Device>>

### [B-1]

A method of controlling a distance measuring device including:

upon control of the distance measuring device including a light source section that irradiates a subject with light, a light receiving device that receives reflected light from the subject, and an application processor that controls the light source section and the light receiving device,

measuring a distance to the subject to detect that the subject approaches within a predetermined distance, and providing notification of a result of such detection to the application processor in a standby state to start up the application processor.

<<C. Electronic Apparatus>>

### [C-1]

An electronic apparatus provided with a distance measuring device, the distance measuring device including:

a light source section that irradiates a subject with light;

a light receiving device that receives reflected light from the subject; and

an application processor that controls the light source section and the light receiving device, in which

the light receiving device has an object detection function of measuring a distance to the subject to detect that the subject approaches within a predetermined distance, and provides notification of a detection result to the application processor in a standby state, and

the application processor starts up in response to the notification from the light receiving device.

### [C-2]

The electronic apparatus according to [C-1], in which the light receiving device performs switching of an internal status of the light receiving device on the basis of the detection result.

### [C-3]

The electronic apparatus according to [C-2], in which the light receiving device performs switching of a status of the light source section on the basis of the detection result.

### [C-4]

The electronic apparatus according to any one of [C-1] to [C-3], in which the light receiving device includes an imaging section including arranged pixels that each include a light receiving element, and performs simple distance measurement in which a distance is measured with use of pixel signals in a partial region within a pixel region of the imaging section. the light receiving device includes an imaging section including pixels that are arranged and each include a light receiving element, and performs simple distance measurement in which a distance is measured with use of pixel signals in a partial region within a pixel region of the imaging section.

### [C-5]

The electronic apparatus according to [C-4], in which

the light source section irradiates the subject with pulsed light to be emitted in a predetermined cycle, and

the light receiving device performs the simple distance measurement by receiving reflected pulsed light from the subject and measuring a time of flight of light from a phase difference between a light emission cycle and a light reception cycle.

### [C-6]

The electronic apparatus according to [C-5], in which in the light source section, at least one of a frequency or a light emission amount of the pulsed light to be emitted is variable, and at least one of the frequency or the light emission amount of the pulsed light is decreased in the simple distance measurement as compared with a case of distance measurement for acquiring a distance map image.

### [C-7]

The electronic apparatus according to any one of [C-1] to [C-6], in which the light receiving device performs imaging in a continuous light emission state, thereby allowing for acquirement of an image.

### [C-8]

The electronic apparatus according to [C-7], in which the light receiving device performs face detection on the basis of the acquired image.

### [C-9]

The electronic apparatus according to [C-8], in which the light receiving device performs impersonation confirmation by detecting facial irregularities on the basis of the acquired image and comparing the facial irregularities with preregistered data.

### [C-10]

The electronic apparatus according to [C-8], in which the application processor performs face authentication on the basis of a distance map image in response to notification of face detection from the light receiving device.

### Reference Signs List

1: distance measuring device
10: subject (distance measurement target)
20: light source section
30: light receiving device
31: imaging section
32: pixel controller
33: pixel modulator
34: column processor
35: proximity object detector
36: data processor
37: output I/F
38: system controller
39: light emission timing controller
40: application processor
41: reference voltage-reference voltage generator
42: PLL circuit
43: light source section status controller
44: proximity object detection timing generator
45: face detection/face authentication section
46: impersonation determining section
47: startup notification timing selecting section

1. A distance measuring device comprising:
a light source section that irradiates a subject with light;
a light receiving device that receives reflected light from the subject; and
an application processor that controls the light source section and the light receiving device, wherein
the light receiving device has an object detection function of measuring a distance to the subject to detect that the subject approaches within a predetermined distance, and provides notification of a detection result to the application processor in a standby state, and
the application processor starts up in response to the notification from the light receiving device.

2. The distance measuring device according to claim 1, wherein the light receiving device performs switching of an internal status of the light receiving device on a basis of the detection result.

3. The distance measuring device according to claim 2, wherein the light receiving device performs switching of a status of the light source section on a basis of the detection result.

4. The distance measuring device according to claim 1, wherein the light receiving device includes an imaging section including pixels that are arranged and each include a light receiving element, and performs simple distance measurement in which a distance is measured with use of pixel signals in a partial region within a pixel region of the imaging section.

5. The distance measuring device according to claim 4, wherein
the light source section irradiates the subject with pulsed light to be emitted in a predetermined cycle, and
the light receiving device performs the simple distance measurement by receiving reflected pulsed light from the subject and measuring a time of flight of light from a phase difference between a light emission cycle and a light reception cycle.

6. The distance measuring device according to claim 5, wherein in the light source section, at least one of a frequency or a light emission amount of the pulsed light to be emitted is variable, and at least one of the frequency or the light emission amount of the pulsed light is decreased in the simple distance measurement as compared with a case of distance measurement for acquiring a distance map image.

7. The distance measuring device according to claim 1, wherein the light receiving device performs imaging in a continuous light emission state, thereby allowing for acquirement of an image.

8. The distance measuring device according to claim 7, wherein the light receiving device performs face detection on a basis of an acquired image.

9. The distance measuring device according to claim 8, wherein the light receiving device performs impersonation confirmation by detecting facial irregularities on a basis of the acquired image and comparing the facial irregularities with preregistered data.

10. The distance measuring device according to claim 8, wherein the application processor performs face authentication on a basis of a distance map image in response to notification of face detection from the light receiving device.

11. A method of controlling a distance measuring device comprising:
upon control of the distance measuring device including a light source section that irradiates a subject with light, a light receiving device that receives reflected light from the subject, and an application processor that controls the light source section and the light receiving device,
measuring a distance to the subject to detect that the subject approaches within a predetermined distance, and providing notification of a result of such detection to the application processor in a standby state to start up the application processor.

12. An electronic apparatus provided with a distance measuring device, the distance measuring device comprising:
a light source section that irradiates a subject with light;
a light receiving device that receives reflected light from the subject; and
an application processor that controls the light source section and the light receiving device, wherein
the light receiving device has an object detection function of measuring a distance to the subject to detect that the subject approaches within a predetermined distance, and provides notification of a detection result to the application processor in a standby state, and
the application processor starts up in response to the notification from the light receiving device.
